(19) United States
(12) Patent Application Publication
(10) Pub. No.: US 2008/0009191 A1
(43) Pub. Date: Jan. 10, 2008

(54) Connector Having a Shielding Plate

(76) Inventors: Robert Van Den Heuvel, Appeltern (NL); Gert Droesbeke, Geel (BE); Erik Verbruggen, Zeeland (NL); Tiny Peters, Zeeland (NL); Jacques Van Loosdrecht, Waalwijk (NL)

Correspondence Address: HARRINGTON & SMITH, PC, 4 RESEARCH DRIVE, SHELTON, CT, 06484-6212, US

(21) Appl. No.: 11/662,739

(22) PCT Filed: Jul. 21, 2005
(86) PCT No.: PCT/EP05/07984

§ 371 Date: Mar. 13, 2007

(30) Foreign Application Priority Data
Sep. 15, 2004 (NL) 1027045

(51) Int. Cl. H01R 13/648

(52) U.S. Cl. 439/608

(57) ABSTRACT

The invention relates to a connector including an insulating housing module and at least one shielding plate. The housing module contains a plurality of signal leads and at least one ground lead extending between a mating end (M) and a contact end (C) of said connector. The shielding plate includes one or more fastening elements contacting said ground lead each having a distal portion and an intermediate portion extending between the shielding plate and the distal portion. The distal portion has a deformable structure for engaging a portion of said ground lead.

The invention relates to a connector comprising an insulating housing module and at least one shielding plate, wherein said housing module contains a plurality of signal leads and at least one ground lead extending between a mating end and a contact end of said connector and wherein said shielding plate comprises one or more fastening elements contacting said ground lead and having a distal portion and an intermediate portion extending between the shielding plate and the distal portion.

EP-A 1 107 387 discloses a connector comprising an insulating housing, a plurality of contact elements arranged in rows and columns in said housing and at least one shielding plate arranged between adjacent columns of contact elements. The shielding plate is a structurally separate part provided with fastening means and is attached only to one of the contact elements of a column of contacts by means of the fastening means.

A drawback of the prior art is that the fastening means require a considerable amount of space between the ground lead and the adjacent signal leads. Accordingly, the lead spacing cannot be reduced to comply with requirements for high density cable connectors at the mating side of the connector.

It is an object of the invention to provide a connector with a shielding plate contacting the ground lead wherein the lead spacing can be reduced in comparison with the lead spacing of the prior art.

This object is achieved by providing a connector characterized in that said distal portion has a deformable structure for engaging a portion of said ground lead. Accordingly, the structure of the fastening elements according to the present invention allows for an elastic deformation of the fastening element substantially parallel to the ground lead. In the prior art, the intermediate portion of the fastening means is deformed to have the opposed tabs snap over the sides of the ground lead. The fastening means therefore develop a contact force with the ground lead parallel to the plane of the shielding plate such that these fastening means deform in the direction from the ground lead towards the signal lead. Therefore, the connector according to the present invention requires less space between the ground lead and the adjacent signal lead than the connector of the prior art and, consequently, the density of signal leads and ground leads can be enhanced.

In an embodiment of the invention at least one distal portion of said fasting elements forms part of a press fit connection with a corresponding portion of said ground lead. This provides for an easy and reliable connection of the shielding plate.

In an embodiment of the invention, the signal leads and ground lead are arranged in a column substantially parallel to said shielding plate and at least one distal portion is arranged between said ground lead and one of said signal leads. The fastening elements of the prior art are provided pair wise at both sides of the ground lead which results in a larger number of fastening elements.

In an embodiment of the invention, at least one distal portion interacts with said insulating housing module. The insulating housing module provides a suitable connector part for the fastening means provided on one side of the ground lead to assist in developing a contact force with the ground lead.

In an embodiment of the invention, said ground lead comprises at least one hole to receive said distal portion. By inserting the fastening element in a hole of the ground lead, no space is required between the ground lead and the adjacent signal lead for accommodating the fastening element. Preferably the hole is provided at the contact end of the ground lead. More preferably the ground lead is broader at said contact end than at said mating end, since a broader ground lead provides a better location for the hole while near the contact end typically the distance between the leads may be larger than at the mating end for a high density connector. It is noted that the hole may also be employed for fastening elements without a deformable structure at the distal portion.

In an embodiment of the invention, the shielding plate comprises one or more shielding flanges extending from said shielding plate and abutting against one or more walls of said insulating housing module. These shielding flanges partly encapsulate the insulating housing module and accordingly ensure that the differential impedance of the connector is only determined by the signal leads, the ground lead and the shielding plate of the connector.

In an embodiment of the invention, the distal portion comprises two wings. The wings may build an angle with a direction parallel to the ground lead. On contacting the ground lead the wings of the fastening element spread along the ground lead to develop a gradually increasing contact force when said wings deform elastically parallel to the ground lead.

The invention also relates to a connector assembly comprising a plurality of connectors or connector modules as described above and a retainer holding said connectors. Typically, board connectors provided on a printed circuit board should be connected to cable connectors having a plurality of leads arranged in rows and columns. The connector assembly according to the invention provides an array of high density connectors with a reduced lead spacing at least at the mating end of the connector.

In an embodiment of the invention, the insulating housing modules each comprise one or more extensions and said retainer comprises slots to receive said extensions. In this embodiment, the retainer is suitable to hold the arrayed connectors.

It is noted that the above described embodiments, or aspects thereof, can be combined.

The invention will be further illustrated with reference to the attached drawings, which schematically show preferred embodiments according to the invention. It will be understood that the invention is not in any way restricted to these specific and preferred embodiments.

In the drawings:

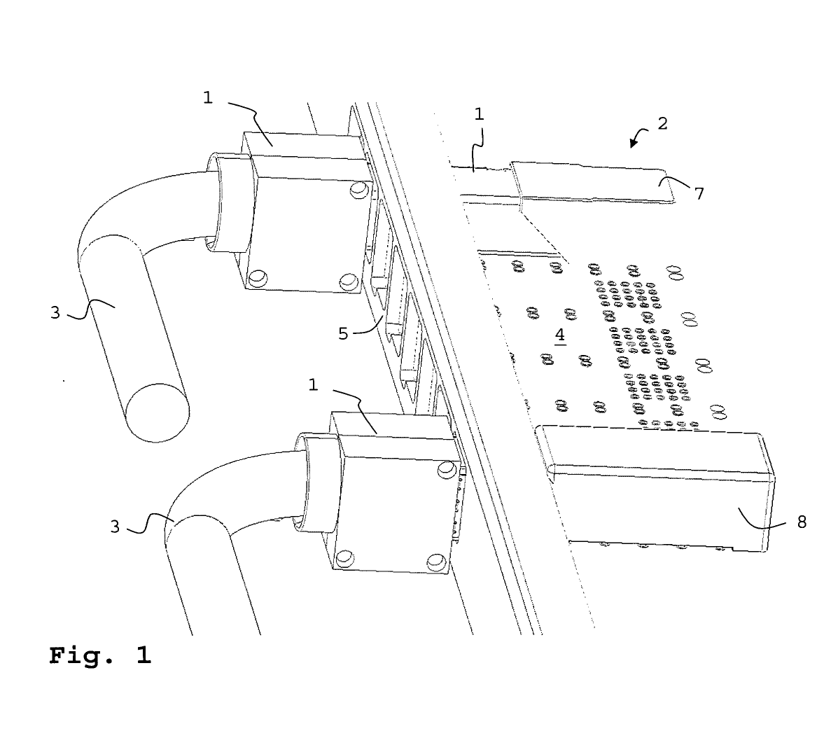

FIG. 1 displays a connector system according to an embodiment of the invention;

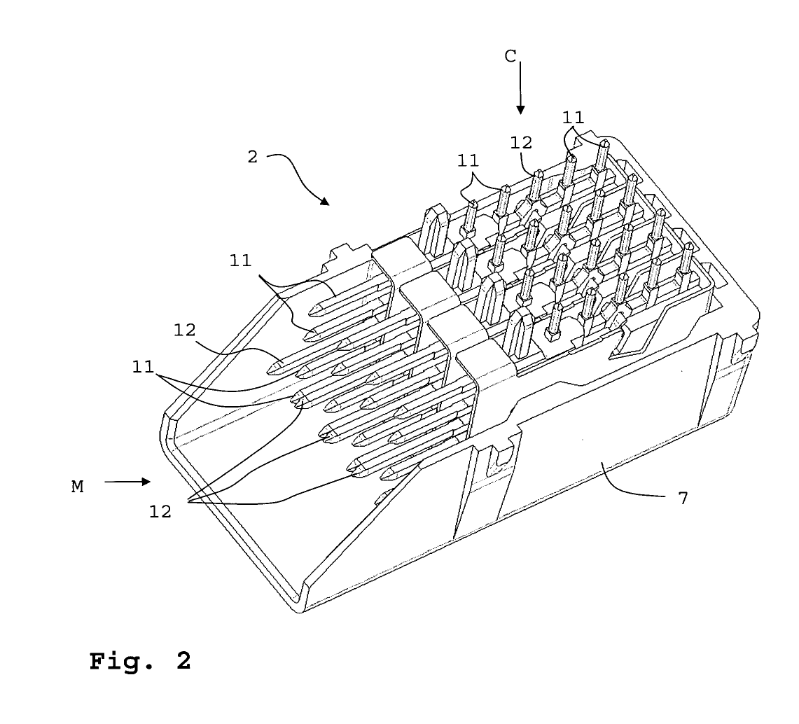

FIG. 2 shows a connector assembly according to an embodiment of the invention;

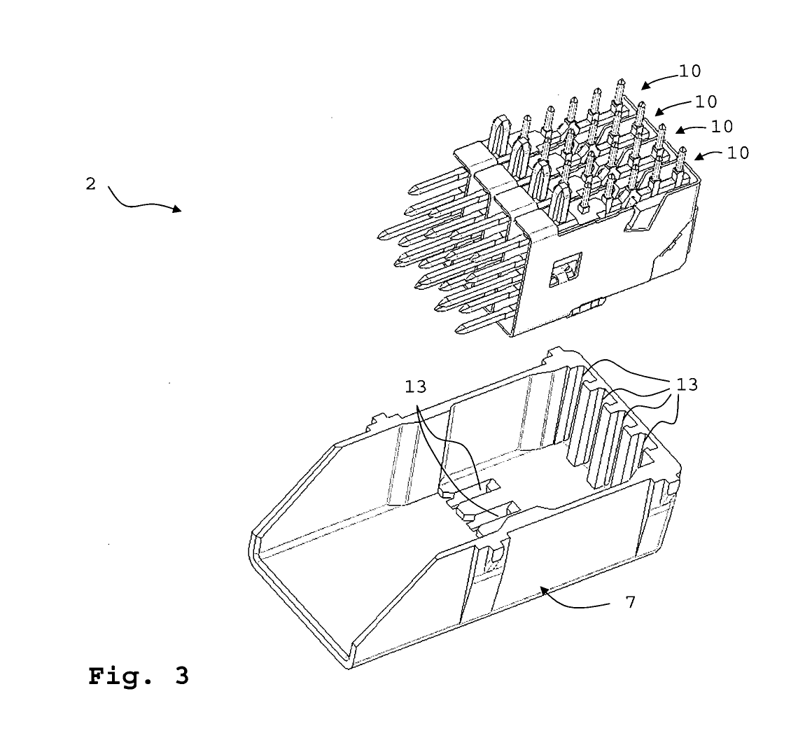

FIG. 3 shows the connector assembly of FIG. 2, wherein the retainer and a plurality of connectors according to an embodiment of the invention are separated;

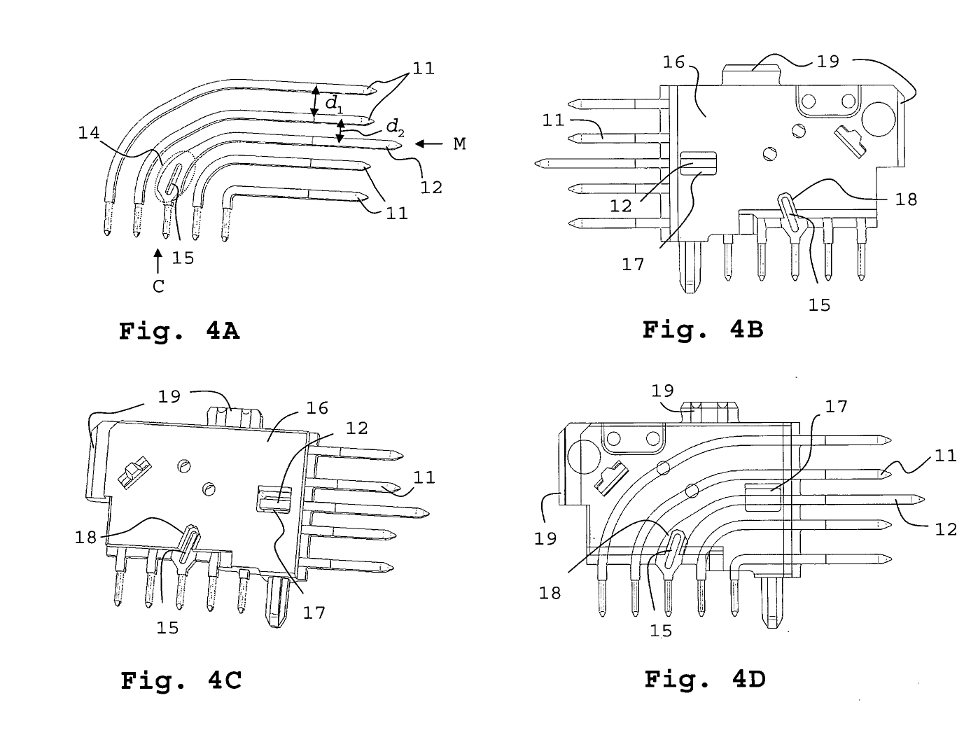

FIGS. 4A-4D display several views of several components of a single connector of the plurality of connectors shown in FIG. 3 without a shielding plate;

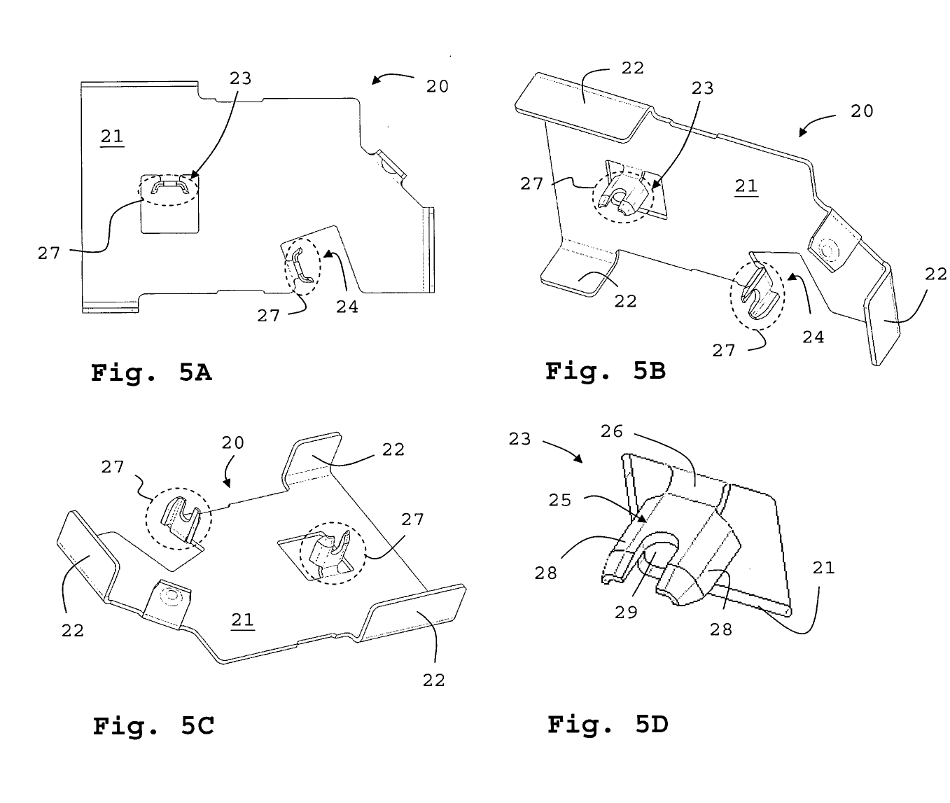

FIGS. 5A-5D display several views of the shielding plate for the connector of FIGS. 4A-4D, and

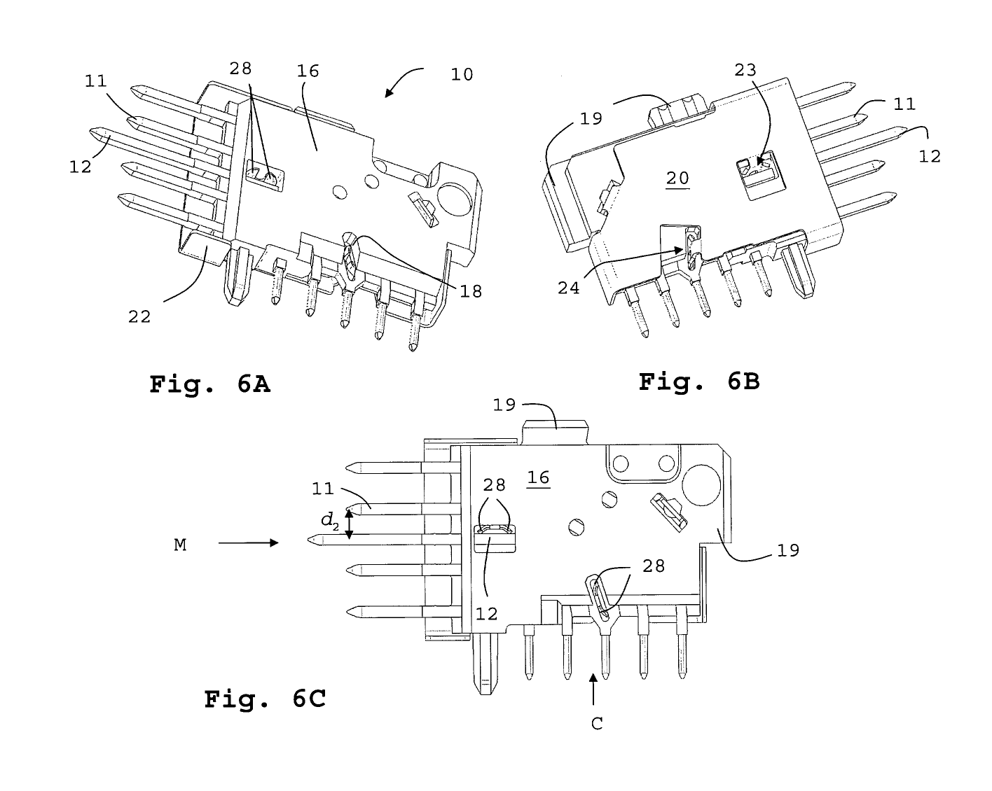

FIGS. 6A-6C display several views of an assembled connector according to an embodiment of the invention.

In FIG. 1 a high density connector system is displayed, wherein a cable connector 1 and a board connector assembly 2 provide an electrical connection of wires (not shown) of a cable 3 to components (not shown) on a circuit board 4. The cable connector 1 comprises a diecast base section, a diecast housing part and a sheet metal housing part as described in WO2004/057707 which is herewith incorporated by reference in the present application that can be inserted in a panel 5. The board connector assembly 2 includes a retainer 7 and may be covered be a shielding cage 8. This shielding cage has been previously described in WO2004/057709 and is herewith incorporated by reference in the present application.

FIGS. 2 and 3 show the connector assembly 2 of FIG. 1 according to an embodiment of the invention. The connector assembly 2 comprises a plurality of right-angled connectors 10 each having signal leads 11 and a ground lead 12 arranged in a column and extending between a mating end M and a contact end C. The signal leads 11 and ground lead 12 at the mating end M are arranged to contact the cable connector 1. The retainer 7 comprises slots 13 to hold the connectors 10.

FIGS. 4A-4D display several views of several components of a connector 10 of the plurality of connectors shown in FIGS. 2 and 3.

FIG. 4A displays high density right-angled conducting leads or terminals forming the signals leads 11 and the ground lead 12. The lead spacing d₁ at the mating end M is 1.5 mm between respective signal leads 11 and the lead spacing d₂ between the ground lead 12 and the adjacent signal lead 11 is 1.1 mm. At the contact end C the lead spacing requirements are less severe. Accordingly, the ground lead 12 has a broader portion 14 near the contact end C wherein a hole 15 is provided.

FIGS. 4B-4D show several views of the lead assembly accommodated in an insulating housing module 16, e.g. an insert moulded leadframe assembly (IMLA). In FIG. 4D the copper alloy leads 11, 12 are drawn visibly for clarity purposes although in practice they would almost always be obscured by the plastic housing module 16. The insulating housing module 16 holds the leads 11, 12 in position.

The insulating housing module 16 has an opening 17 giving access to the space between the ground lead 12 and an adjacent signal lead 11. Further, the insulating housing module has a recess 18 enabling full access to the hole 15 in the ground lead 12 near the contact end C. The opening 17 and recess 18 are preferably located such that access to the ground lead is provided near the mating end M respectively the contact end C. The insulating housing module 16 may comprise other holes or recesses. Finally, the insulating housing module 16 comprises extensions 19 adapted to cooperate with the recesses or slots 13 of the retainer 7 as shown in FIG. 3. Consequently, the connectors 10 can be hold by the retainer 7.

FIGS. 5A-5D display a shielding plate 20 in various views. The shielding plate 20 has the function to reduce the influence of external noise sources on the quality of the signal The shielding plate 20 is metallic and comprises a planar portion 21 and shielding flanges 22 extending from the sides of the shielding plate 20 away from the planar portion 21. The shielding flanges 22 enable control of the differential impedance of the connector 10.

Further, the shielding plate 20 has a first fastening element 23 and a second fastening element 24 extending in the same direction as the shielding flanges 22. Each of the fastening elements 23,24 comprises a distal portion 25 and an intermediate portion 26 extending between the planar portion 20 and the distal portion 25. The distal portions 25 comprise a deformable structure 27. The deformable structure 27 comprises wings 28 and a gap 29 in the embodiment of FIG. 5D. The backside of the deformable structure 27 abutting against the insulating housing 16 has a larger surface to distribute forces over the larger area in order not to damage the housing 16. On the other hand, the side of the deformable structure 27 facing the ground lead 12 has a small area to have a large contact force per unit area. Other deformable structures are envisaged and fall under the scope of the present invention. The openings in the planar portion 21 were found to be only of negligible influence for the electromagnetic shielding performance of the connector 10.

FIGS. 6A-6C depict the connector 10 having a shield plate 20 connected according to an embodiment of the invention. The fastening elements 23, 24 are respectively inserted in the opening 17 of the insulating housing module 16 and the hole 15 of the ground lead 12 to engage a portion of the ground lead 12. During this insertion, the wings 28 of the fastening element 23 spread along the upper side of the ground lead 12 in the direction of the ground lead 12 as a result of interaction with the insulating housing module 16 at the opening 17 and forms a press fit connection. On the other hand, the wings 28 of the fastening element 24 spread gradually in the hole 15 of the ground lead 12 to form a press fit connection. Accordingly, the shielding plate 20 is reliably and easy attached to the insulating housing module 16 to form the connector 10 while the lead distance d₂, defined in FIG. 4A, is reduced. As the connection of the shielding plate 20 to the ground lead 12 is provided near the mating end M and the contact end C, respectively the return current in the shielding plate 20 is substantially parallel to the current in the signal leads 11 which is advantageous for the performance of the connector 10.

The shielding flanges 22 abut the walls of the insulating housing module 16. Accordingly, the differential impedance of each connector 10 can be adequately controlled.

For the connector assembly 2, shown in FIGS. 2 and 3, a plurality of connectors 10 as shown in FIGS. 6A-6C are positioned adjacent to each other to form a matrix of signal leads 11 and ground leads 12 wherein each column of leads is separated by a shielding plate 20.

It should be noted that the embodiment of the connector described above does not limit the scope of the invention; further modifications are possible such as other deformable structures at the distal portion 25 of the fastening elements 23,24.

1. A connector comprising an insulating housing module and at least one shielding plate, wherein said housing module contains a plurality of signal leads and at least one ground lead extending between a mating end (M) and a contact end (C) of said connector and wherein said shielding plate comprises one or more fastening elements contacting said ground lead each having a distal portion and an intermediate portion extending between the shielding plate and the distal portion characterized in that said distal portion has a deformable structure for engaging a portion of said ground lead, that deforms elastically substantially parallel to the ground lead.

2. The connector according to claim 1, wherein at least one distal portion of said fasting elements forms part of a press fit connection with a corresponding portion of said ground lead.

3. The connector according to claim 1, wherein said signal leads and ground lead are arranged in a column parallel to said shielding plate and at least one distal portion is arranged between said ground lead and one of said signal leads.

4. The connector according to claim 1, wherein said at least one distal portion interacts with said insulating housing module.

5. The connector according to claim 1, wherein said ground lead comprises at least one hole to receive said distal portion.

6. The connector according to claim 5, wherein said hole is provided at the contact end (C) of said ground lead.

7. The connector according to claim 5, wherein said ground lead has a broadened portion at said contact end (C).

8. The connector according to claim 1, wherein said shielding plate comprises a planar portion and one or more shielding flanges extending from said planar portion and abutting against one or more walls of said insulating housing module.

9. The connector according to claim 1, wherein said distal portion comprises two wings.

10. The connector according to the preamble of claim 1, wherein said ground lead comprises at least one hole receiving a fastening element, in particular the distal portion of said fastening element.

11. The connector according to claim 10, wherein said hole is provided at the contact end (C) of said ground lead.

12. A connector assembly comprising a plurality of connectors according to claim 1 and a retainer holding said connectors.

13. The connector assembly according to claim 12, wherein said insulating housing modules each comprise one or more extensions and said retainer comprises slots to receive said extensions.
